(19) United States
(12) Patent Application Publication
(10) Pub. No.: US 2009/0121509 A1
(43) Pub. Date: May 14, 2009

(54) Mobile Cleaning Units and Systems

(76) Inventors: Annissa Coy, Addy, WA (US); Ron Osborne, Clarkston, WA (US)

Correspondence Address: WELLS ST. JOHN P.S., 601 W. FIRST AVENUE, SUITE 1300, SPOKANE, WA, 99201, US

(21) Appl. No.: 12/264,747

(22) Filed: Nov. 4, 2008

Related U.S. Application Data
(63) Continuation-in-part of application No. 11/983,087, filed on Nov. 6, 2007.

(51) Int. Cl. B60P 3/14

(52) U.S. Cl. 296/24.32; 296/24.4

(57) ABSTRACT

Mobile restoration vehicles are provided having at least one axle, with the vehicle comprising a base supported by the axle; walls extending vertically from the base of the vehicle; and a roof supported by the walls, the base, walls, and roof defining at least a portion of the perimeter of the vehicle. The first wall can define an opening configured to receive materials to be restored. Within the perimeter along a second wall an ultrasonic cleaning apparatus can be placed. Along a second wall, opposite the first wall, a contaminated material staging area can be placed. The vehicle can include an ultrasonic cleaning apparatus placed along one wall within the trailer, a staging area along another wall within the trailer, and drying shelves within the above bed portion of the trailer.

### RELATED PATENT DATA

The present disclosure is a continuation-in-part of U.S. patent application Ser. No. 11/983,087 filed Nov. 6, 2007 and entitled “Mobile Cleaning Units and Systems”.

### TECHNICAL FIELD

The present disclosure relates to mobile cleaning units and systems.

### BACKGROUND

Disaster settings and as well as non-disaster settings brought about by flood and/or fire, for example, have required decontamination teams moving into areas into which they have not had to move before. Fire and/or flood water damage to the property inside dwellings in the disaster areas can be salvaged and part of this salvage can require cleaning and/or decontamination.

It has proven difficult in the past to mobilize the equipment necessary to clean and/or decontaminate this property and move this equipment to the disaster site. The present disclosure provides mobile decontamination apparatuses and methods of using same such as mobile cleaning units.

### BRIEF DESCRIPTION OF THE DRAWINGS

Embodiments of the invention are described below with reference to the following accompanying drawings.

FIG. 1 is a floor plan of a mobile decontamination apparatus according to an embodiment.

FIG. 2 is a floor plan including dimensions of the apparatus of FIG. 1 according to an embodiment.

FIG. 3 is an interior elevation of the apparatus of FIG. 1 according to an embodiment.

FIG. 4 is an interior elevation of FIG. 3 including dimensions according to an embodiment.

FIG. 5 is an interior elevation of the mobile apparatus of FIG. 1 according to an embodiment.

FIG. 6 is the elevation of FIG. 5 including dimensions according to an embodiment.

FIG. 7 is an assembly for use in mobile decontamination apparatus.

FIG. 8 is an assembly for use in mobile decontamination apparatus.

FIG. 9 an elevation of a mobile decontamination apparatus according to an embodiment.

FIG. 10 is a floor plan of the mobile decontamination apparatus of FIG. 9 according to an embodiment.

FIG. 11 is an interior side elevation of the mobile decontamination apparatus of FIG. 9 according to an embodiment.

FIG. 12 is another interior side elevation of the mobile decontamination apparatus of FIG. 9 according to an embodiment.

FIG. 13 is another interior side elevation of the mobile decontamination apparatus of FIG. 9 according to an embodiment.

FIG. 14 is a floor plan of another mobile decontamination apparatus according to an embodiment.

FIG. 15 is an interior side elevation of the mobile decontamination apparatus of FIG. 14 according to an embodiment.

FIG. 16 is another interior side elevation of the mobile decontamination apparatus of FIG. 14 according to an embodiment.

FIG. 17 is another interior side elevation of the mobile decontamination apparatus of FIG. 14 according to an embodiment.

FIG. 18 is a floor plan of another mobile decontamination apparatus according to an embodiment.

### DESCRIPTION

This disclosure is submitted in furtherance of the constitutional purposes of the U.S. Patent Laws “to promote the progress of science and useful arts” (Article 1, Section 8).

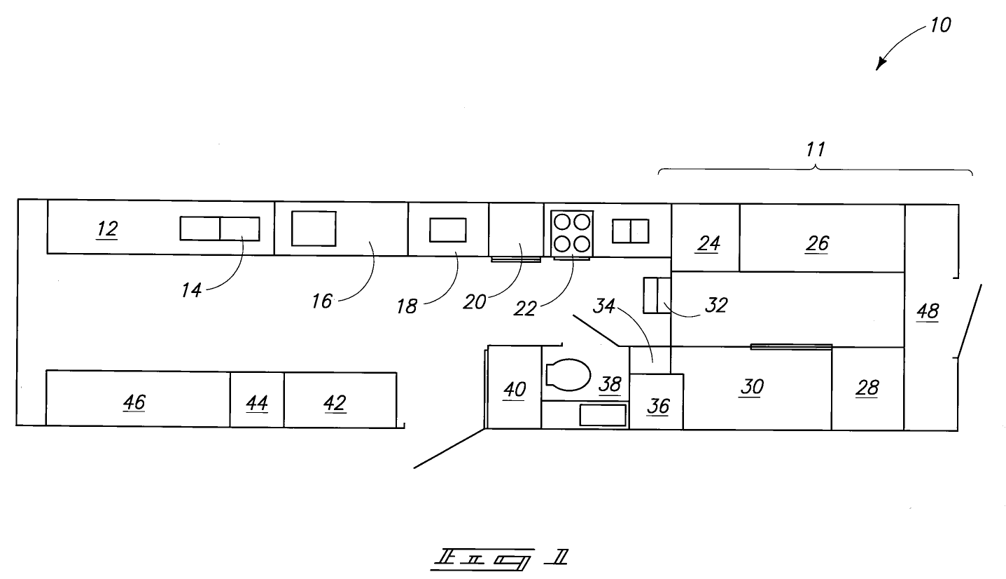

The mobile restoration apparatus of the present disclosure will be described with reference to FIGS. 1-19. Referring to FIG. 1, mobile apparatus 10 can be a trailer, such as a dual wheeled trailer or what is referred to as a fifth-wheel trailer. The apparatus can also be a motorized vehicle such as box van or cab over vehicle. The trailer itself can have a weight of approximately 21,000 lbs. and an approximate square footage of less than 600 sq. ft, from about 600 to about 300 sq. ft, and/or even less than 300 sq. ft. Example trailers include those manufactured by Forest River Trailers, Inc. According to example embodiments, the trailer itself can include a rear door allowing for access directly to the rear of the trailer. The door can be oversized, in fact as large as five to six feet wide or larger. The door itself can be of the roll-up variety and/or it can be the classic swing-open door.

The trailer itself can contain cleaning equipment such as an ultrasonic cleaner as well as an ozone room and a drying room. The trailer itself can have a base supported by an axle and then walls extending vertically above the axle from the base of the vehicle. A roof can be supported by the walls, with the base, walls, and roof defining at least a portion of the perimeter of the vehicle with the first wall defining an opening configured to receive materials to be restored.

Along the perimeter of the trailer along the second wall can be placed an ultrasonic cleaning apparatus such as ultrasonic cleaning apparatus 16, for example. An example ultrasonic cleaning apparatus can be the Omega Fire Pro 3600, produced and sold by Omegasonics Corporation. Apparatus 16 can have a size of 36 inches in length, 18 inches in width, and 20 inches in depth, with an overall dimension of 59 inches in length, 21 inches in width, and 34 inches in height.

Along a second wall opposite the first wall of the trailer, a contaminated material staging area 46 can be placed with the opening providing access to both the ultrasonic cleaning apparatus and the staging area. According to another embodiment, along the first wall described above at least a sink 18 can be placed proximate the ultrasonic cleaning apparatus. According to another embodiment, along the first wall, two sinks can be placed with the ultrasonic cleaning apparatus 16 being between a double sink 14 and a sink 18. Along a second wall and opposite the ultrasonic cleaning apparatus a computer area 44 proximate the contaminated material staging area 46 can be placed. Vehicle 10 can have an above-bed portion 11. This is typically the area on fifth-wheel trailers that is above the pick-up truck bed that hauls the trailer. Within this above-bed portion, drying shelves 24 may be placed as well as a box storage area 26. Along the front of the trailer and having an access door thereto, an ozone room 48 can be placed, and a portion below the bed portion can be configured to house utility components such as generators, hot water heaters, compressors, and the like in area 28. Vehicle 10 may also include a drying room 30 that may be placed proximate a dehumidifier 36. Closet for storage 40 may be placed next to a lavatory 38 and an extra, smaller closet 34. Steps 32 can be provided to an access area to the above-bed portion of vehicle 10. Vehicle 10 may likewise include a kitchenette area including a stove 22 and a refrigerator 20. Additional contaminated counter area 12 may be provided towards the rear access point or fold-down access door of vehicle 10.

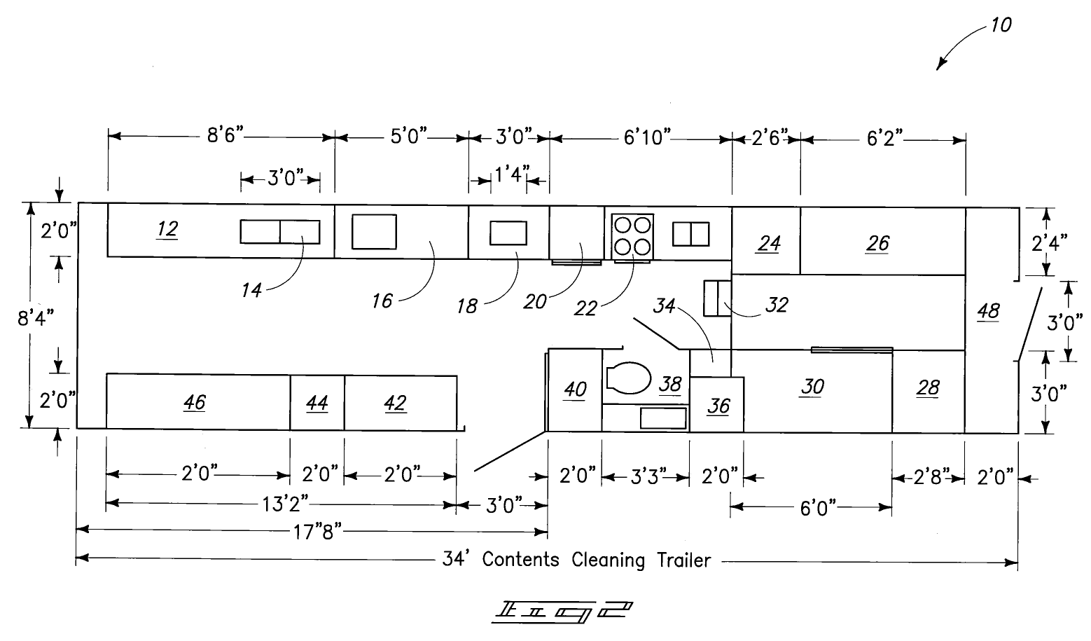

Referring to FIG. 2, example dimensions of vehicle 10 are provided. These dimensions are meant for example purposes only, and the scope and contents of the present disclosure, particularly the claims, should not be limited to such dimensions.

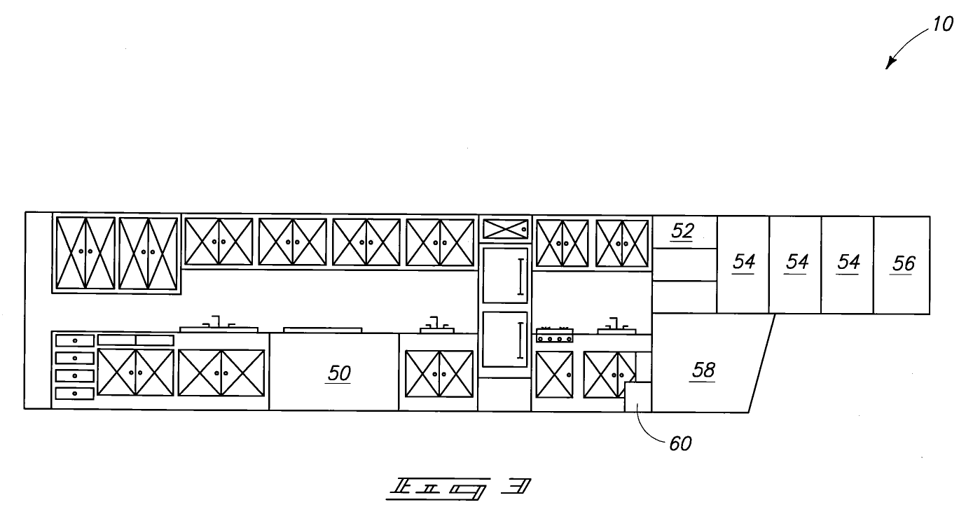

Referring to FIG. 3, an elevation of apparatus 10 is shown according to an embodiment. Ultrasonic cleaner 50 is placed along this elevation and also includes box rack 52 as well as box storage areas 54 and ozone room 56. Propane tanks can be stored in utility room 58. A cross-section of steps 60 heading up to the above storage compartment area is shown as well.

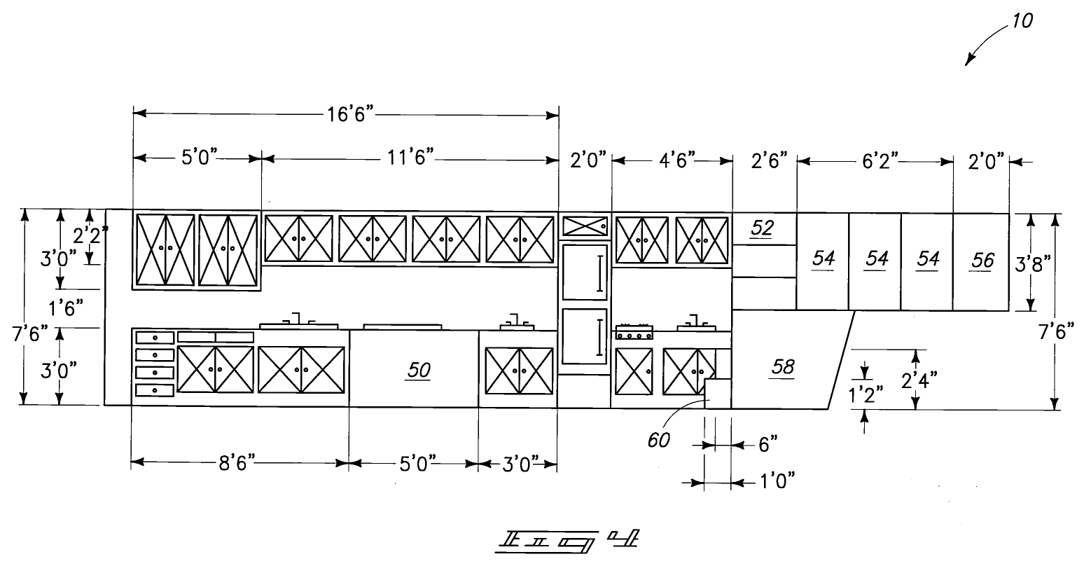

Referring to FIG. 4, detailed dimensions of these components with relation to this elevation are shown as well. Again, the subject matter of the disclosure should not be limited to these dimensions.

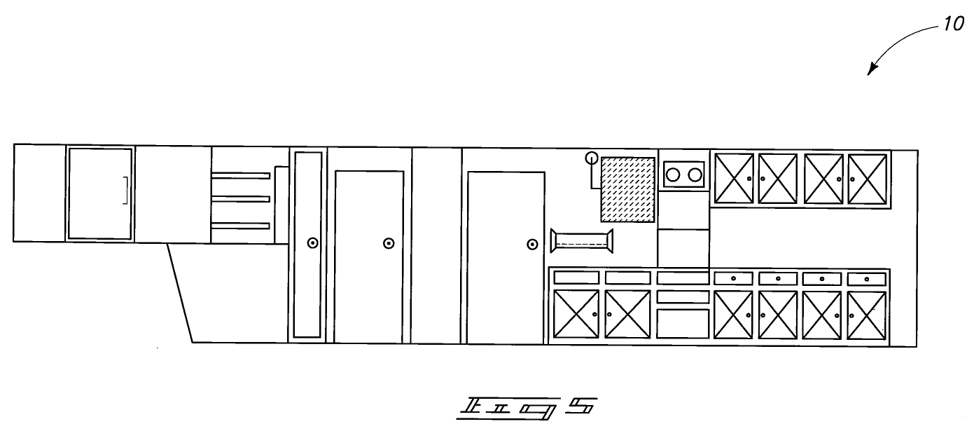

Referring to FIG. 5, another elevation of vehicle 10, the opposing elevation to the previous elevation, is shown.

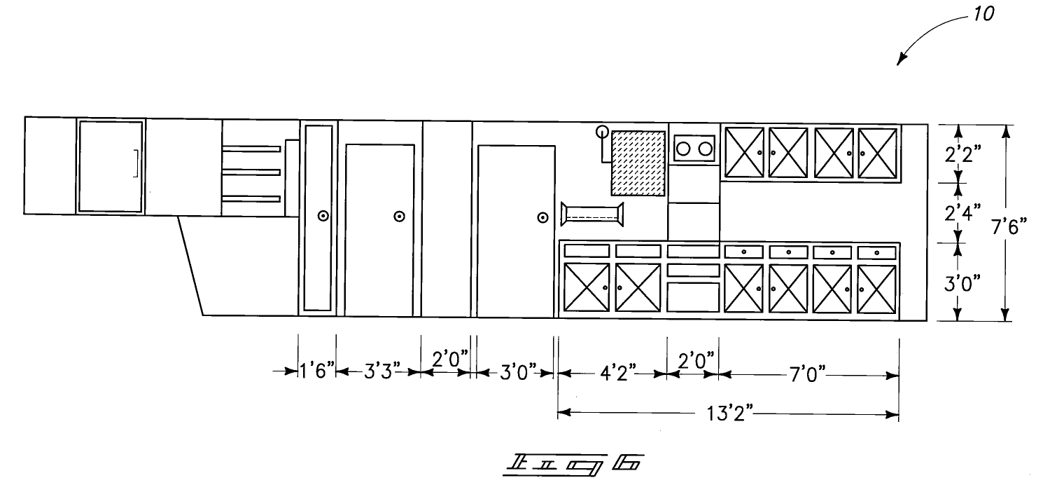

Referring to FIG. 6, an elevation including dimensions of elevation of FIG. 5 is shown in FIG. 6. Again, the subject matter of the disclosure should not be limited to these dimensions.

According to example embodiments, a process for restoring materials can include providing contaminated materials to within mobile restoration vehicle 10. The process can also include ultrasonically cleaning the contaminated materials within the restoration vehicle, drying the cleaned materials within the vehicle, and then finally removing the cleaned materials from the vehicle.

According to example embodiments, the contaminated materials can be provided to within the mobile restoration vehicle through a rear opening in the restoration vehicle. As another implementation, the contaminated materials can be staged on one side of the restoration vehicle before being ultrasonically cleaned on the opposing side of the vehicle. The process can also include, upon ultrasonically cleaning materials on one side of the vehicle, drying the cleaned materials in a forward portion of the vehicle. The method can also include ozonizing the materials before removing the materials from the vehicle.

According to yet another embodiment, the mobile restoration vehicle cleaning platform can include an ultrasonic cleaning apparatus along a first wall, a staging area along a second wall, with the first wall opposing the second wall. A computer area can also be part of the restoration vehicle proximate the staging area, and a packing area can be proximate the computer desk, with the computer area being between the staging area and the packing area. The vehicle can also include a drying area proximate both the ultrasonic cleaning apparatus and the packing area. According to an example embodiment, the restoration vehicle platform can be based on the shape of a triangular pattern with the ultrasonic cleaning apparatus, the staging area and the drying area being arranged at different corners of the triangular pattern. According to another embodiment, the triangular pattern can include an ultrasonic cleaning apparatus, a computer area, and a drying area being placed at different corners of the triangular pattern. In yet another implementation, the ultrasonic cleaning apparatus, the staging area and the packing area can be arranged at different corners of the triangular pattern.

A quadrangular pattern for components within the vehicle can also be utilized. For example, the ultrasonic cleaning apparatus, the staging area, the computer area, and the drying area can be arranged in a quadrangular pattern with each of these components being placed at different corners of the quadrangular pattern. According to an example implementation, the quadrangular pattern can include as well a staging area that is adjacent the computer area that is part of the quadrangular pattern. The present disclosure provides the arrangement of these components within a vehicle that is lightweight as well as easily mobilized to disaster areas. The arrangements of the components within the trailer itself allow for the user to quickly and efficiently move contaminated materials through the trailer and provide efficient cleaning of the materials and restoration of the materials.

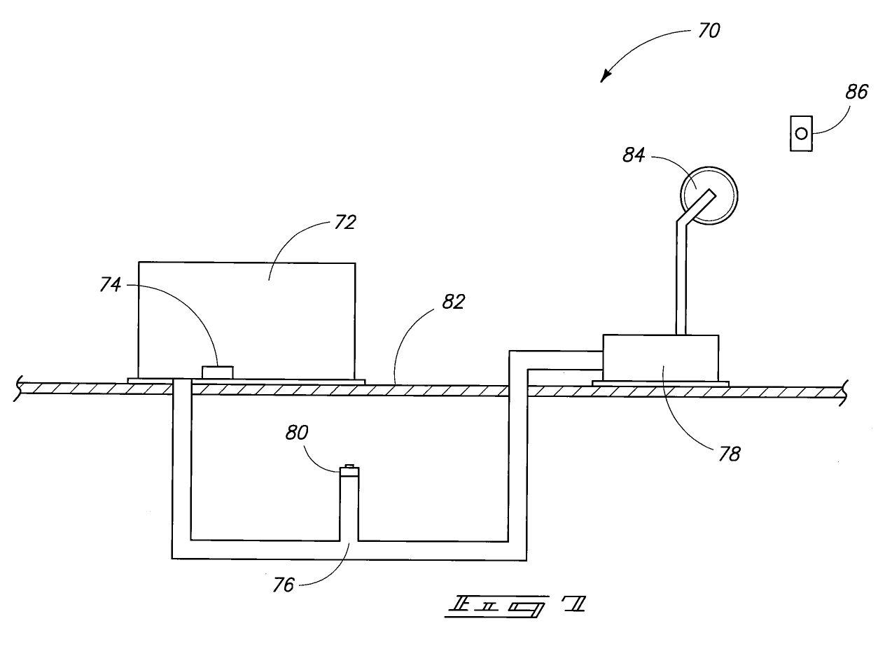

Referring to FIG. 7, the mobile decontamination apparatuses can each include a waste assembly 70. Assembly 70 can be configured to contain and dispose of waste materials such as contamination material from processed material. Assembly 70 can include a waste tank 72 having a pump switch 74 therein such as a bilge pump switch (e.g., Rule-a-Matic float switch mfr #35A). Tank 72 can be coupled via conduit 76 to pump 78. Conduit 76 can be a pipe such as 1½″ ABS pipe. Pump 78 can be a macerator pump such as Jabsco-Macerator pump (mfr #185902092). Coupled to conduit 76 can be sealable drain 80. Drain 80 can be configured below the horizontal elevation of the lowest most portion of conduit 76, for example. Both tank 72 and pump 78 can be configured to rest above apparatus subfloor 82. Pump 78 can be configured to couple to waste hose 84. Located on the apparatus is also pump switch 86 which is operatively connected to both switch 74 and pump 78, for example. Switch 86 can be configured as a Blue Sea Systems-Bilge pump control panel with switch and fuse mfr #8263.

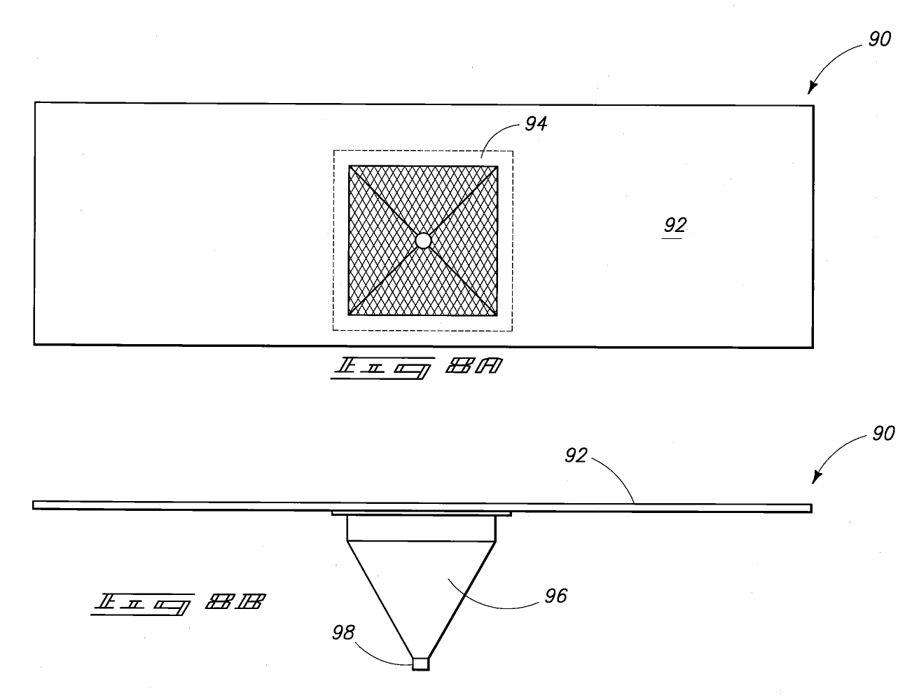

Referring to FIGS. 8A and 8B, the apparatuses can each include downdraft cleaning station 90. Station 90 can include a counter encompassing a screen 94. Screen 94 can be coupled to funnel 96 which is connected to vacuum line 98. In operation, during decontamination within the apparatus materials are removed and drawn past screen 94 by vacuum from hose 98.

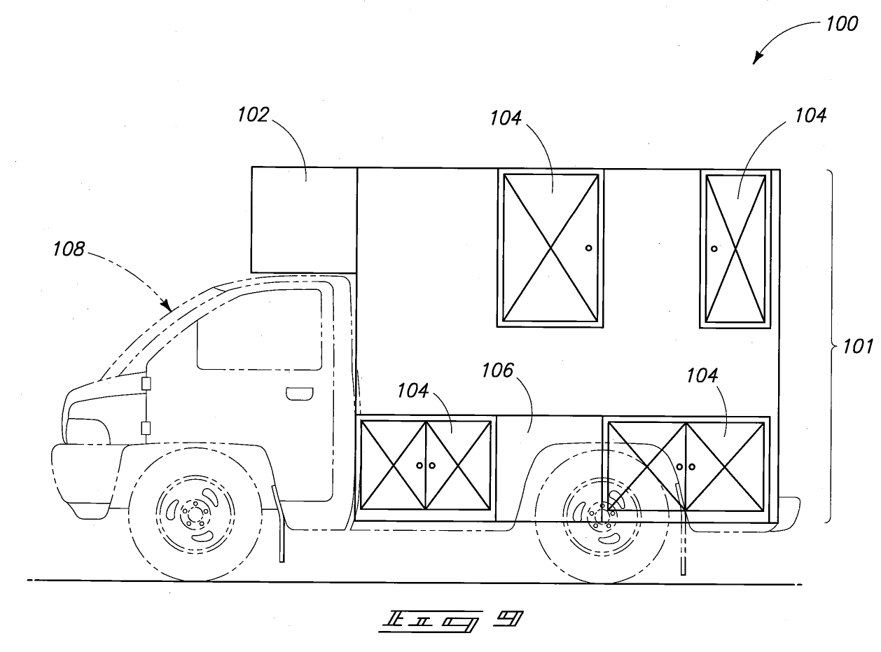

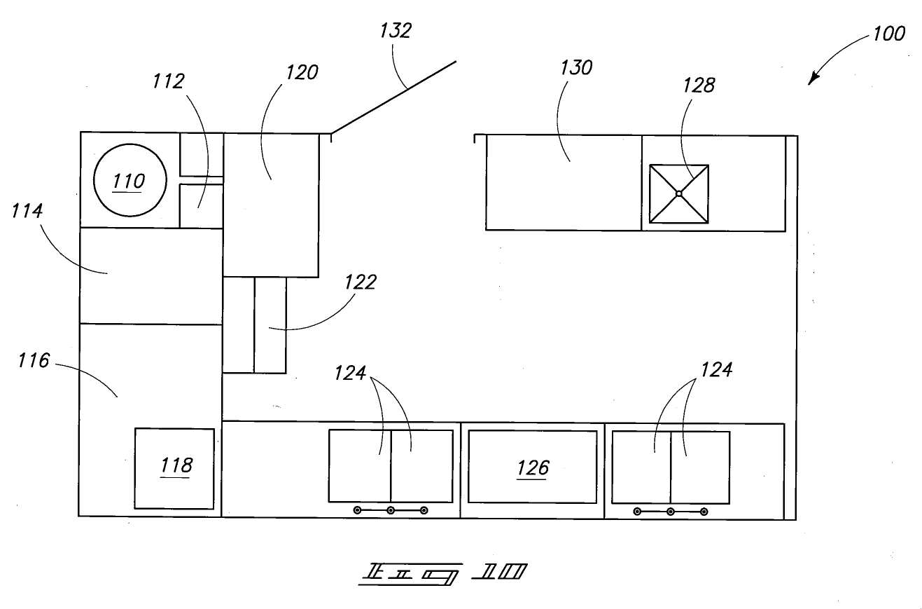

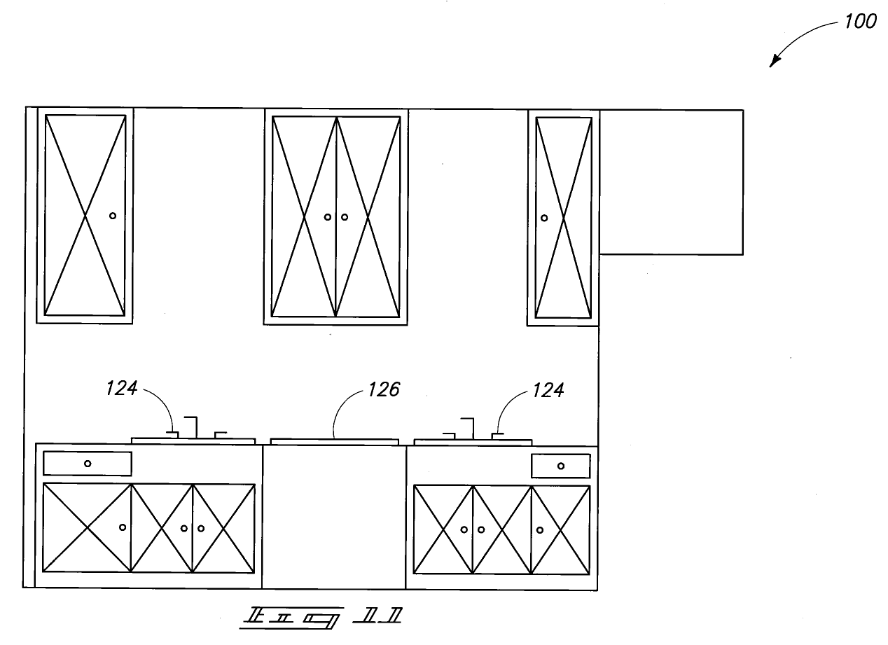

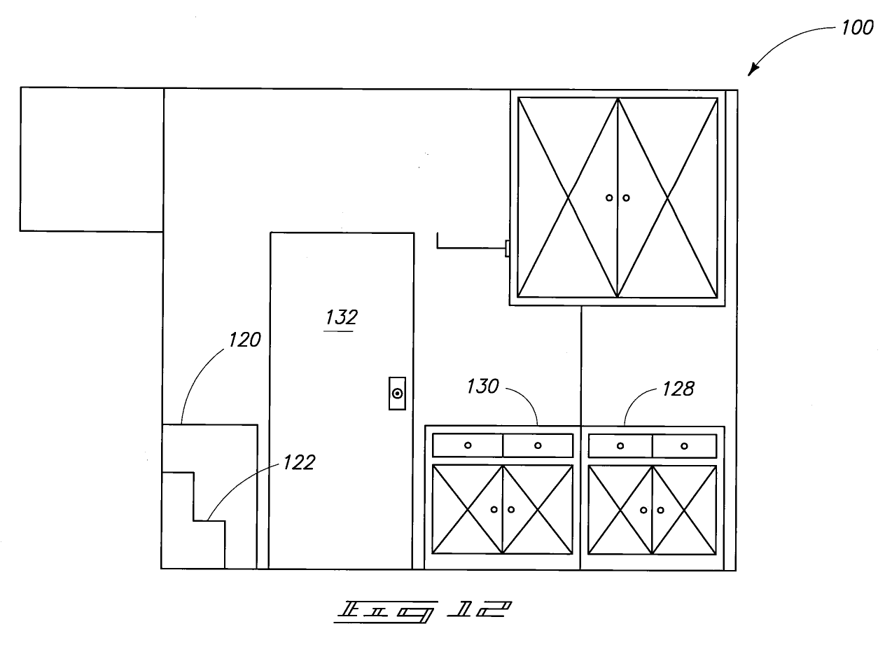

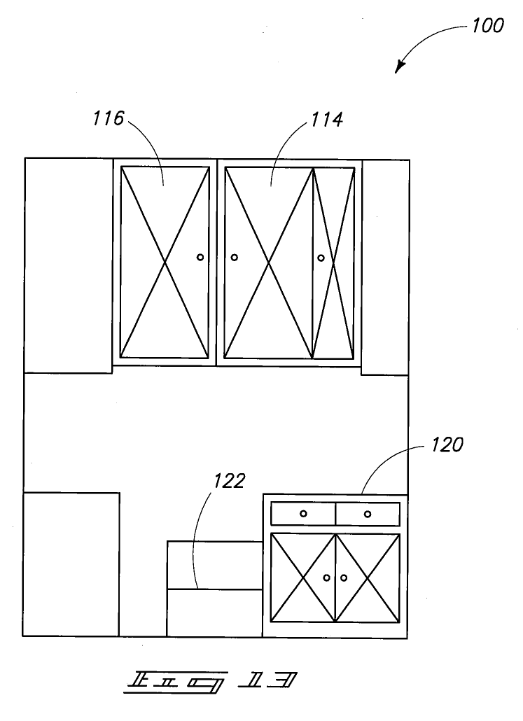

Referring to FIG. 9 another embodiment of the present disclosure provides a self motorized or non-trailer apparatus 100. As shown in FIG. 9, apparatus 100 is demonstrated in a cut away view to include locations for storage 102, cabinets 104 and ultrasonic sink 106 and within compartment 101 which is fixedly attached to vehicle 108. Referring to FIG. 10, in the above cab compartment, vacuum 110, compressed air 112, ozone room 114, drying room 116 and dehumidifier 118 can be placed. A counter 120 can be within the main compartment and next to stairs 122. Sinks 124 can be on opposite sides of ultrasonic cleaning apparatus 126. Across from sinks 124 can be packing station 130 and downdraft assembly 128. Referring to FIG. 11, side elevation of apparatus 100 can include cabinets above and below sinks 124. Referring to FIG. 12 between counter 120 and station 130 can be door 132. Above and or below assembly 128 are cabinets. Referring to FIG. 13, front view of interior of apparatus 100 is shown indicating cabinets from enclosing drying room 116 and ozone room 114.

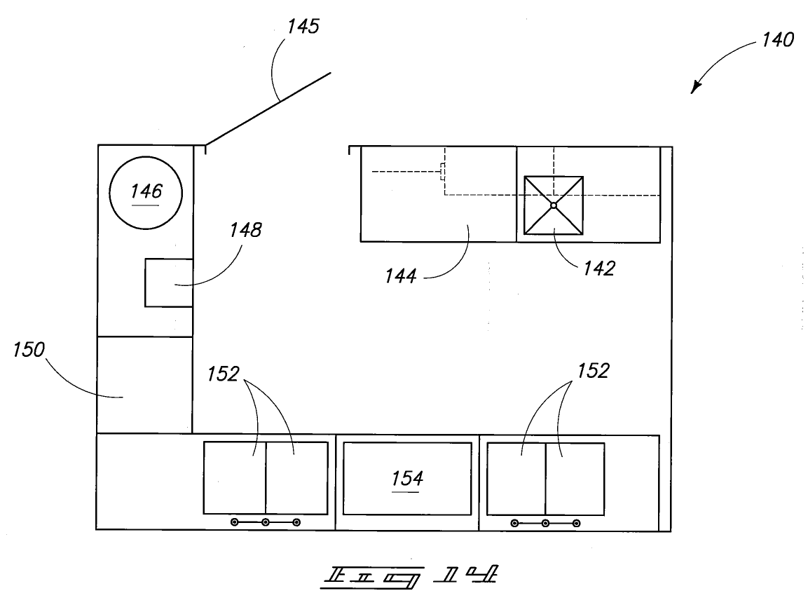

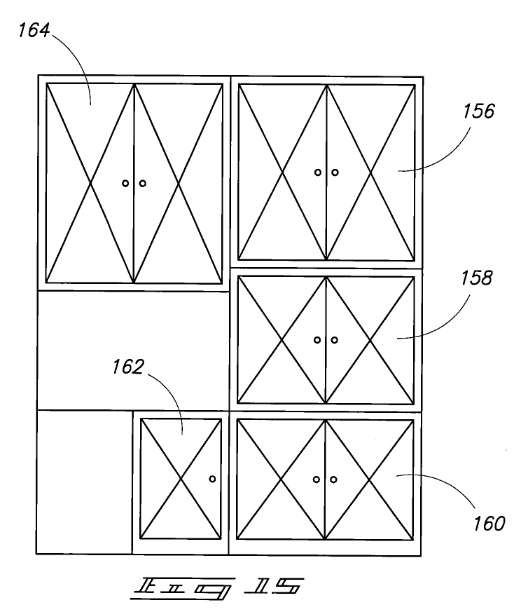

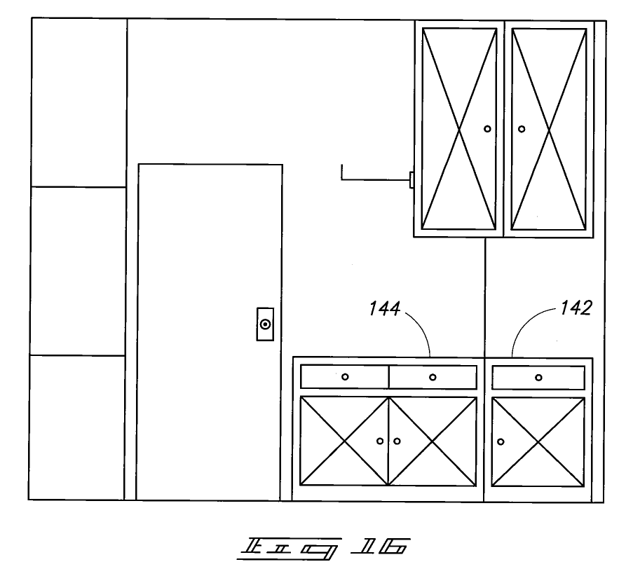

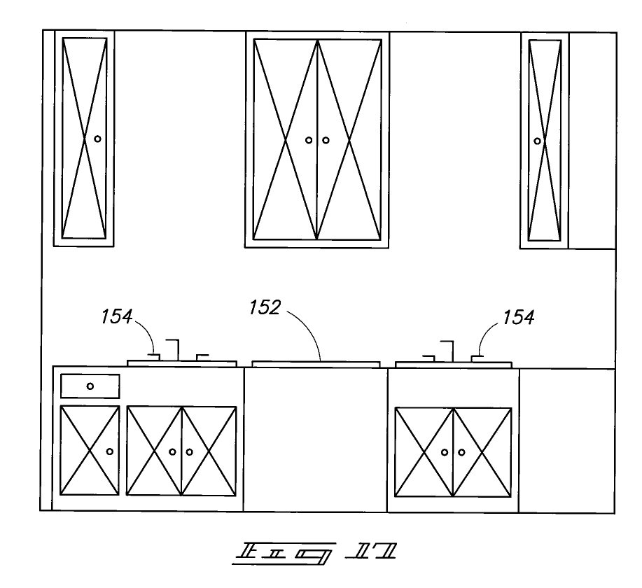

Referring to FIGS. 14-17 and according to another implementation having no cab over, apparatus 140 is configured as a compartment such as that of a box van. The compartment can be configured to enclose down draft assembly 142 proximate packing station 144. Door 145 can be placed proximate packing station 144. The compartment can also include vacuum apparatus 146 proximate air supply 148 and ozone generator 150. Ultrasonic sink 154 can be located between sinks 152. Referring to FIG. 15, a front view of the compartment is shown demonstrating the cabinets configured for enclosing vacuum and compressor 156 as well as ozone 158 and drying 160 cabinets. The compartment can also include dehumidifier cabinet 162 and storage cabinet 164. Referring to FIG. 16 a side elevation is shown demonstrating the cabinets surrounding station 144 and down draft assembly 142. Referring to FIG. 17 another side view is shown demonstrating the cabinets surrounding sinks 152 and ultrasonic sink 154.

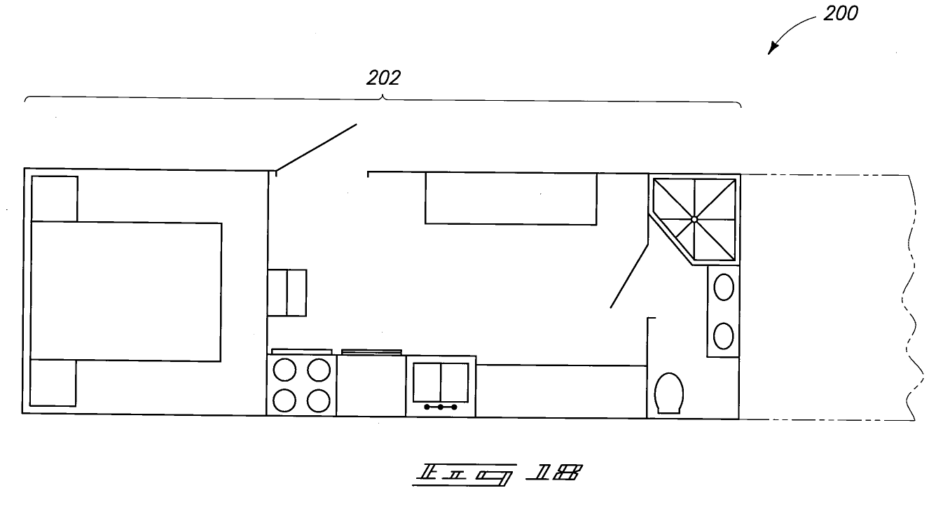

Referring to FIG. 18, according to another embodiment, apparatus 200 can be configured with residential quarters 202. The residential quarters can be configured within the front portion of a fifth wheel trailer for example.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect. The invention is, therefore, claimed in any of its forms or modifications within the proper scope of the appended claims appropriately interpreted in accordance with the doctrine of equivalents.

What is claimed is:

1. A mobile restoration vehicle having at least one axle, the vehicle comprising:
a base supported by the axle;
walls extending vertically from the base of the vehicle;
a roof supported by the walls, the base, walls, and roof defining at least a portion of the perimeter of the vehicle, and wherein a first wall defines an opening configured to receive materials to be restored; and
within the perimeter along a second wall an ultrasonic cleaning apparatus is placed, and along a second wall, opposite the first wall, a contaminated material staging area is placed, the opening providing access to both the ultrasonic cleaning apparatus and the staging area.

2. A mobile restoration vehicle as claimed in claim 1, and wherein along the first wall at least one sink is proximate the ultrasonic apparatus.

3. A mobile restoration vehicle as claimed in claim 1, and wherein along the first wall two sinks are placed, the ultrasonic apparatus having a sink on either side.

4. A mobile restoration vehicle as claimed in claim 1, and wherein along the second wall a computer area is proximate the contaminated material staging area.

5. A fifth wheel trailer configured to perform restoration services, the trailer including:
an ultrasonic cleaning apparatus placed along one wall within the trailer;
a staging area along another wall within the trailer; and
drying shelves within the above bed portion of the trailer.

6. A fifth wheel trailer as claimed in claim 5, and wherein the above bed portion of the trailer is further configured to store packing boxes.

7. A fifth wheel trailer as claimed in claim 5, and wherein the above bed portion of the trailer is further configured to house an ozonolysis apparatus.

8. A fifth wheel trailer as claimed in claim 5, and wherein a portion of the trailer below the above bed portion is configured to house utility components.

9. A fifth wheel trailer as claimed in claim 8, and wherein at least one of the utility components is a generator.

10. A process for restoring materials comprising:
providing contaminated materials to within a mobile restoration vehicle,
the mobile restoration vehicle having a weight of less than 21,000 lbs.;
ultrasonically cleaning the contaminated materials within the restoration vehicle;
drying the cleaned materials within the vehicle; and
removing the cleaned materials from the vehicle.

11. A process for restoring materials as claimed in claim 10, and wherein the contaminated materials are provided to within the mobile restoration vehicle through a rear opening in the restoration vehicle.

12. A process for restoring materials as claimed in claim 10, and wherein the contaminated materials are staged on one side of the restoration vehicle before being ultrasonically cleaned on an opposing side of the vehicle.

13. A process for restoring materials as claimed in claim 10, and wherein, upon being ultrasonically cleaned on one side of the vehicle the cleaned materials are dried at a forward portion of the vehicle.

14. A process for restoring materials as claimed in claim 10, and wherein the cleaned materials are ozonized before being removed from the vehicle.

15. A mobile restoration vehicle cleaning platform comprising:
an ultrasonic cleaning apparatus along a first wall;
a staging area along a second wall, the first wall opposing the second wall;
a computer area proximate the staging area;
a packing area proximate the computer desk, the computer area being between the staging area and packing area; and
a drying area proximate both the ultrasonic cleaning apparatus and the packing area.

16. A mobile restoration vehicle cleaning platform as claimed in claim 15, and wherein the ultrasonic cleaning apparatus, the staging area, and the drying area are arranged in a triangular pattern with each of these components being placed at a different corner of the triangular pattern.

17. A mobile restoration vehicle cleaning platform as claimed in claim 15, and wherein the ultrasonic cleaning apparatus, the computer area, and the drying area are arranged in a triangular pattern with each of these components being placed at a different corner of the triangular pattern.

18. A mobile restoration vehicle cleaning platform as claimed in claim 15, and wherein the ultrasonic cleaning apparatus, the staging area, and the packing area are arranged in a triangular pattern with each of these components being placed at a different corner of the triangular pattern.

19. A mobile restoration vehicle cleaning platform as claimed in claim 15, and wherein the ultrasonic cleaning apparatus, the staging area, the computer area, and the drying area are arranged in a quadrangular pattern with each of these components being placed at a different corner of the quadrangular pattern.

20. A mobile restoration vehicle cleaning platform as claimed in claim 15, and wherein the staging area is adjacent the computer area.
